(19) United States
(12) Patent Application Publication
(10) Pub. No.: US 2003/0126596 A1
(43) Pub. Date: Jul. 3, 2003

(54) Viewing restriction method and apparatus

(75) Inventor: Eun-Mi Kim, Gyeonggi-do (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-City (KR)

(21) Appl. No.: 10/321,570

(22) Filed: Dec. 18, 2002

(30) Foreign Application Priority Data
Dec. 29, 2001 (KR) 2001-88222

(51) Int. Cl. H04N 7/16

(52) U.S. Cl. 725/30; 725/25

(57) ABSTRACT

A viewing restriction method of selecting desired contents and recording/reproducing the contents onto/from an optical recording medium includes setting a password using a menu for restricting viewing of contents, storing the password in a preliminary region of a certain stream of the contents, recording the contents in the optical recording medium, and reproducing the stored contents if a newly input password is identical with the password stored in the preliminary region of the certain stream of the contents. Accordingly, it is possible to prevent minors from viewing violent or sex-related materials by setting viewing restriction information or the password in a certain region of the contents or setting a section of the contents to which a viewing restriction function is applied during recording the contents.

### CROSS-REFERENCE TO RELATED APPLICATIONS

This application claims the benefit of Korean Application No. 2001-88222, filed Dec. 29, 2001 in the Korean Intellectual Property Office, the disclosure of which is incorporated herein by reference.

### BACKGROUND OF THE INVENTION

1. Field of the Invention

The present invention relates to a method of recording/reproducing information onto/from an optical recording medium, and more particularly, to a method of restricting recording/viewing of video scenes from an optical storage medium on which information on restricting the viewing access of certain users is previously set.

2. Description of the Related Art

Nowadays, parents and educators worry about a quality of a TV program affecting young viewers. Since a video data broadcast to TVs may include scenes of extreme violence or sexual nature, and children do not have a well-established judgment yet and are vulnerable to such scenes, undesirable scenes from the video data broadcast must be filtered out on a voluntary or compulsory basis.

In addition, with the widespread use of DVD, minors can easily have access to inappropriate storage electronic materials, such as contents involving sex, violence, or the like, which may adversely affect many of the minors.

### SUMMARY OF THE INVENTION

To solve the above and the other problems, it is an aspect of the present invention to provide a viewing restriction method and apparatus, which can prevent contents from being indiscreetly reproduced by setting viewing restriction information or a password.

It is another aspect of the present invention to provide a viewing restriction method apparatus, which can predetermine a viewing restriction section of contents in a certain area of the contents when recording the contents thereof on an optical recording medium, and can selectively reproduce the viewing restriction section when reproducing the viewing restriction section recorded in the certain area of the recorded contents from the optical storage medium when the contents are reproduced from the optical storage medium, such as a DVD.

Additional aspects and advantages of the invention will be set forth in part in the description which follows and, in part, will be obvious from the description, or may be learned by practice of the invention.

To achieve one aspect of the invention, a viewing restriction method and apparatus for selecting desired contents and recording/reproducing the contents onto/from an optical recording medium includes setting a password using a menu for restricting viewing of the contents, storing the password in a preliminary region of a certain stream of the contents, recording the contents in the optical recording medium, and reproducing the stored contents from the optical recording medium if a newly input pin number is identical with the password stored in the preliminary region of the certain stream of the contents.

The preliminary region, in which the password is stored, is a preliminary region of a predetermined information table used to record/reproduce information about the contents into/from the optical recording medium. The reproducing of the stored contents includes recording the newly input password and providing a manager with information about the newly input password if the newly input password is not identical with the previously stored password.

To achieve another aspect of the invention, a viewing restriction method and apparatus for recording/reproducing multiple contents onto/from an optical recording medium includes setting viewing restriction information on predetermined contents, storing the viewing restriction information in a preliminary region of a certain stream of the multiple contents, recording the multiple contents in the optical recording medium, selecting desired contents from the multiple contents except the predetermined contents in which the viewing restriction information is set, and reproducing the selected contents.

The preliminary region, in which the viewing restriction information is recorded, is a preliminary region of a predetermined information table used to record/reproduce information about the contents into/from the optical recording medium. The reproducing of the selected contents includes sequentially displaying the multiple contents except the predetermined contents in which the viewing restriction information is set. The predetermined contents, in which the viewing restriction information is set, is reproduced only by a manager who inputs information corresponding to the viewing restriction information.

To achieve still another aspect of the invention, a viewing restriction method and apparatus for selecting desired contents and recording/reproducing the contents into/from an optical recording medium includes setting a password using a menu for restricting viewing of the contents and storing information on the password, storing a starting point of the information on the password in a preliminary region of a certain stream of the contents, recording the contents in the optical recording medium, accessing the preliminary region, and reproducing the contents from the optical recording medium if a newly input password is identical with the password stored in the preliminary region.

The preliminary region, in which the starting point of the information on the password is stored, is a preliminary region of a predetermined information table used to record/reproduce information into/from the optical recording medium. The reproducing of the contents includes recording the newly input password and providing information about the newly input password to a manager, who inputs the password identical to the previously stored password, if the newly input password is not identical with the previously stored password.

To achieve still another aspect of the invention, a viewing restriction method and apparatus for selecting desired contents and recording/reproducing the contents into/from an optical recording medium includes setting a section of the contents, viewing of which is desired to be restricted, setting a password to reproduce the viewing-restricted section, storing the password in a preliminary region of a certain stream of the contents when recording the whole contents in the optical recording medium, and reproducing the viewing-restricted section from the optical recording medium if a newly input password is identical with the password stored in the preliminary region.

The preliminary region, in which the password is stored, is a preliminary region of a predetermined information table used to record/reproduce information into/from the optical recording medium. The reproducing of the viewing restricted section includes recording the wrong password and providing the same to a manager if the newly input password is not identical with the previously stored password.

According to still another aspect of the invention, a viewing restriction method and apparatus for selecting desired contents and recording/reproducing the contents into/from an optical recording medium includes setting a section of the contents, viewing of which is desired to be restricted, storing information on the viewing restricted section to be viewing-restricted in a preliminary region of a certain stream of the contents when recording the contents in the optical recording medium, and reproducing the contents except the viewing-restricted section.

The preliminary region, in which the information on the viewing-restricted region is stored, is a preliminary region of a predetermined information table used to record/reproduce information into/from the optical recording medium. The viewing-restricted section can be reproduced only when a manager inputs information corresponding to the information on the viewing restricted section.

To achieve still another aspect of the invention, a viewing restriction method and apparatus for selecting desired contents and recording/reproducing the contents into/from an optical recording medium includes setting a section of the contents, viewing of which is desired to be restricted, setting a password to reproduce the viewing-restricted section, and storing information on the viewing-restricted section when recording the contents in the optical recording medium, storing a starting point of the information on the viewing-restricted section in a preliminary region of a certain stream of the contents and recording the contents in the optical recording medium, and accessing the preliminary region and reproducing the contents from the optical recording medium if a newly input password is identical with the password stored in the preliminary region.

The preliminary region, in which the starting point of the information on the viewing-restricted section is stored, is a preliminary region of a predetermined information table used to record/reproduce information into/from the optical recording medium. The reproducing of the contents includes recording an incorrectly input password in a memory and providing a manager, who inputs the correct password, with the stored incorrectly input password if the newly input password is not identical with the previously stored password.

To achieve still another aspect of the invention, a viewing restriction method and apparatus for selecting desired contents and recording/reproducing the contents into/from an optical recording medium in an optical disk player includes setting a section of the contents, viewing of which is desired to be restricted, and storing information on the viewing-restricted section when recording the contents, storing a starting point of the information on the viewing-restricted section in a preliminary region of a certain stream of the contents, recording the contents in the optical recording medium, and reproducing the contents except the viewing-restricted section.

The preliminary region, in which the information on the viewing-restricted section is stored, is a preliminary region of a predetermined information table used to record/reproduce information into/from the optical recording medium. The viewing-restricted section can be reproduced from the optical recording medium only when a manager inputs information corresponding to the stored information on the viewing-restricted section.

### BRIEF DESCRIPTION OF THE DRAWINGS

These and/or other aspects and advantages of the present invention will become more apparent and more readily appreciated from the following description of the preferred embodiments, taken in conjunction with the accompanying drawings of which:

FIG. 1 is a block diagram showing a structure of a viewing restriction device;

FIG. 2 is a flowchart of a viewing restriction method according to an embodiment of the present invention;

FIG. 3 is a flowchart of a viewing restriction method according to another embodiment of the present invention;

FIG. 4 is a flowchart of a viewing restriction method according to another embodiment of the present invention;

FIG. 5 is a flowchart of a viewing restriction method according to another embodiment of the present invention;

FIG. 6 is a flowchart of a viewing restriction method according to another embodiment of the present invention;

FIG. 7 is a flowchart of a viewing restriction method according to another embodiment of the present invention; and

FIG. 8 is a flowchart of a viewing restriction method according to another embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, the present invention will be described more fully with reference to the accompanying drawings.

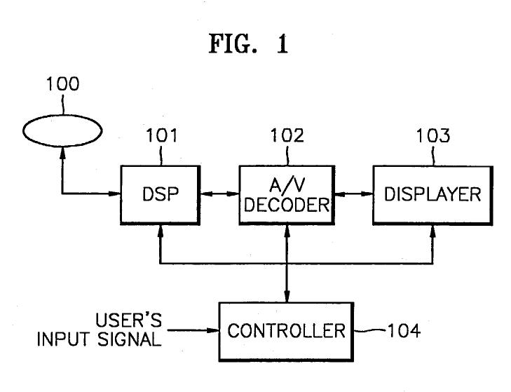

FIG. 1 is a block diagram showing a structure of a viewing restriction device of an optical disk recording and/or reproducing apparatus. Referring to FIG. 1, the viewing restriction device includes an optical disk 100, a digital signal processor (DSP) 101, an audio/video (A/V) decoder 102, a displayer 103, and a controller 104.

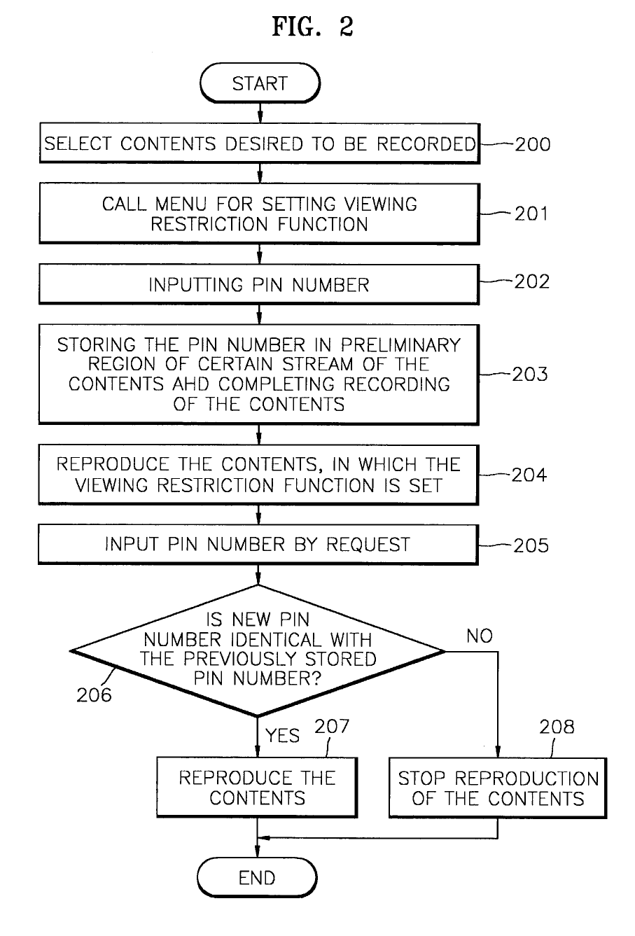

FIG. 2 is a flowchart of a viewing restriction method according to an embodiment of the present invention. Referring to FIG. 2, the viewing restriction method includes selecting contents desired to be recorded in operation 200, calling a first menu of setting a viewing restriction function in operation 201, inputting a pin number (password) in operation 202, storing the pin number in a preliminary region of a certain stream and completing recording of the contents in operation 203, reproducing the recorded contents, in which the viewing restriction function is set, in operation 204, inputting numbers at a request of the controller 104 in operation 205, determining whether the newly-input pin number is the same as the previously-stored pin number in operation 206, reproducing the corresponding contents in operation 207, and stopping the reproduction of the corresponding contents in operation 208.

The present invention will be described in greater detail with reference to FIGS. 1 and 2. A user selects contents desired to be recorded in operation 200. In a case of recording the contents displayed on the displayer 103, a second menu of recording contents is called in response to an input signal input by the user or generated by keys provided with a remote controller or a player. The controller 104 displays the second menu of recording contents on the displayer 103 in response to the input signal. Then, the user can select a function of “recording of contents” from the second menu of recording contents displayed on the displayer 103.

If the contents desired to be recorded by the user are determined as inappropriate to people under age, like contents of violence or sex, the first menu for setting the viewing restriction function is called in response to the input signal in operation 201. The controller 104 displays the first menu for setting the viewing restriction function in response to the input signal and requests the pin number, i.e., the password.

The user inputs the pin number at the request of the controller 104 in operation 202. The user who inputs the password is the same as a manager who manages reproduction of the contents by inputting the same password.

If the user, i.e., the manager, inputs the password, the controller 104 stores the password in the preliminary region of the certain stream and completes recording of the entire contents in operation 203. The preliminary region of the certain stream is a preliminary region of various information tables for recording or reproducing contents, in which information on the optical disk 100 or the title of the contents is contained.

For example, there is a volume information table in the optical disk 100, in which information required to reproduce the optical disk 100 is stored. The volume information table includes a video title set information (VTSI) management table and a video manager information (VMGI) management table. The password for viewing restriction is stored in at least one of preliminary regions of the VTSI and VMGI management tables. The VTSI management table is a table in which video title set information (VTSI) is stored, and is constituted of 2048 bytes. The preliminary region of the VTSI management table, in which the password for viewing restriction is recorded, is located between the 16^{th} and 27^{th} bytes, between the 38^{th} and 127^{th} bytes, between the 132^{nd} and 191^{st} bytes, between the 232^{nd} and 255^{th} bytes, between the 268^{th} and 339^{th} bytes, between the 348^{th} and 511^{th} bytes, between the 580^{th} and 595^{th} bytes, between the 790^{th} and 791^{st} bytes, and/or between the 984^{th} and 2047^{th} bytes. The VMGI management table is a table in which video management information is stored, and is constituted of 2292 bytes. The preliminary region of the VMGI management table, in which the password for viewing restriction is recorded, is located between the 16^{th} and 27^{th} bytes, between the 48^{th} and 61^{st} bytes, between the 104^{th} and 127^{th} bytes, between the 136^{th} and 191^{st} bytes, between the 224^{th} and 255^{th} bytes, between the 268^{th} and 339^{th} bytes, and/or between the 348^{th} and 1023^{rd} bytes.

After the recording of the contents is completed, the user reproduces the contents, in which the viewing restriction function is set, in operation 204, and the controller 104 accesses the password stored in the preliminary region and demands the user to input a password to reproduce the contents.

The user inputs the password at the request of the controller 104 in operation 205. The controller 104 determines whether the newly input password and the password stored in the preliminary region are identical in operation 206. If the newly input password is determined to be identical with the previously stored password by the controller 104, the corresponding contents are reproduced in operation 207. A pickup unit (not shown) reads an A/V signal from the optical disk 100. The A/V signal read by the pickup unit scrambled and modulated in an eight to fourteen modulation (EFM) form in the DSP 101 is unscrambled and demodulated. The A/V signal processed in the DSP 101 is decoded in the A/V decoder 102 and displayed on the displayer 103.

If the newly input password is not identical with the previously-stored password by the controller 104, the reproducing of the corresponding contents is stopped in operation 208. Since the user may input wrong numbers by mistake, it is allowed for the user to have a predetermined number of chances to input the password correctly. If the newly input password is still not identical with the previously-stored password after the predetermined number of password entry tries, the reproduction of the corresponding contents is stopped. In addition, the incorrect password input by any disk user are sequentially stored in a memory (not shown) of the optical disk recorder and/or player by the controller 104 and are provided to the manager who inputs the correct password to controller 104. The manager can find out when the disk user tried to reproduce the contents and what contents the user tried to reproduce based on the incorrectly input password. The memory may be disposed in the controller 104.

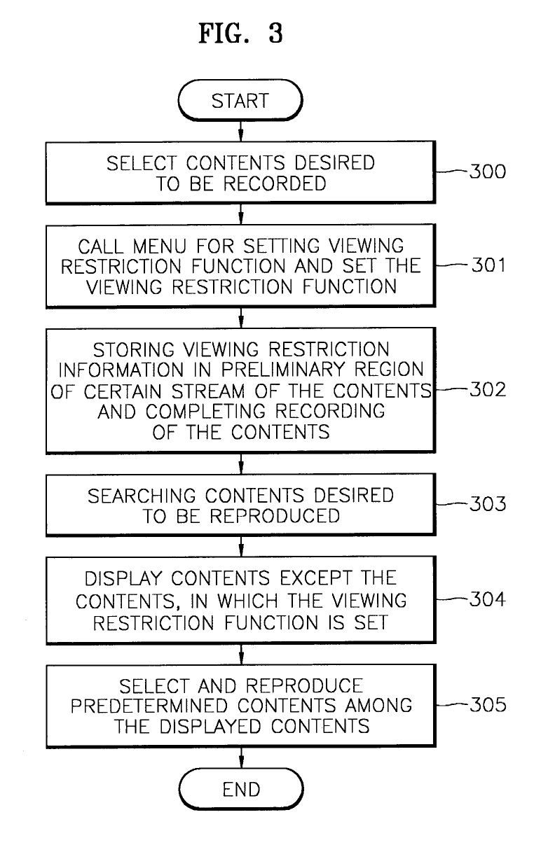

FIG. 3 is a flowchart of a viewing restriction method according to another embodiment of the present invention. Referring to FIG. 3, the viewing restriction method includes selecting contents desired to be recorded in operation 300, calling a first menu for setting a viewing restriction function and setting the viewing restriction function in operation 301, storing viewing restriction information on predetermined contents in a preliminary region of a certain stream of the contents and completing recording of all contents in operation 302, searching for all contents desired to be reproduced in operation 303, displaying a search result for all contents except the contents that are viewing-restricted in operation 304, and selecting desired contents among the searched contents and reproducing the selected contents in operation 305.

Next, the present invention will now be described in greater detail with reference to FIGS. 1 and 3.

A user selects contents desired to be recorded in operation 300. In a case of recording the contents displayed on the displayer 103, a second menu for recording the contents is called in response to the input signal which can be generated by keys provided with a remote controller or a player. The controller 104 displays the second menu for recording the contents on the displayer 103 in response to the input signal. The user can select a function of “recording of contents” from the second menu for recording the contents displayed on the displayer 103.

If the contents desired to be recorded by the user are determined as inappropriate to people underage, like contents of violence or sex, the first menu for setting the viewing restriction function is called in response to the input signal in operation 301. The controller displays the first menu for setting the viewing restriction function in response to the input signal.

The user sets “viewing restriction” in the first menu for setting the viewing restriction function displayed on the displayer 103. The controller 104 stores “viewing restriction” information in a preliminary region of a certain stream and completes the recording of the whole contents in operation 302. The preliminary region of the certain stream is a preliminary region of various information tables for recording or reproducing the contents, in which information on the disk 100 or the title of the contents is contained.

For example, there is a volume information table in the optical disk 100, in which information required to reproduce the optical disk 100 is stored. The volume information table includes a video title set information (VTSI) management table and a video manager information (VMGI) management table. The password for viewing restriction is stored in preliminary regions of the VTSI and VMGI management tables. The VTSI management table is a table, in which video title set information (VTSI) is stored, and is constituted of 2048 bytes. The preliminary region of the VTSI management table, in which the password for viewing restriction is recorded, is located between the 16^{th} and 27^{th} bytes, between the 38^{th} and 127^{th} bytes, between the 132^{nd} and 191^{st} bytes, between the 232^{nd} and 255^{th} bytes, between the 268^{th} and 339^{th} bytes, between the 348^{th} and 511^{th} bytes, between the 580^{th} and 595^{th} bytes, between the 790^{th} and 791^{st} bytes, and/or between the 984^{th} and 2047^{th} bytes. The VMGI management table is a table, in which video management information is stored, and is constituted of 2292 bytes. The preliminary region of the VMGI management table, in which the password for viewing restriction is recorded, is located between the 16^{th} and 27^{th} bytes, between the 48^{th} and 61^{st} bytes, between the 104^{th} and 127^{th} bytes, between the 136^{th} and 191^{st} bytes, between the 224^{th} and 255^{th} bytes, between the 268^{th} and 339^{th} bytes, and/or between the 348^{th} and 1023^{rd} bytes.

The contents desired to be reproduced are searched from the optical disk 100, on which various types of contents are stored, in operation 303. When the input signal for searching contents is input into the controller 104, the controller 104 searches for the information on the contents stored on the optical disk 100.

Next, the controller 104 displays all contents search results except for the contents in which the “viewing restriction” function is set on the displayer 103 in operation 304. For example, suppose five contents C1 through C5 are stored on the optical disk 100 and the “viewing restriction” function is set in a second content C2. In this case, the user can see only titles of four contents C1, C2, C4, and C5. In other words, all the contents C1 through C5 except for the second content C2 are sequentially displayed. Thus, the third content C3 is displayed as the second content C2, the fourth content C4 is displayed as the third content C3, and the fifth content C5 is displayed as the fourth content C4. Accordingly, it is possible to prevent the user from ascertaining that a certain contents might be excluded from the contents search results.

The user selects the desired contents from the contents search results displayed on the displayer 103 and reproduces the selected contents in operation 305. A pickup unit (not shown) reads an A/V signal from the optical disk 100. The A/V signal read by the pickup unit is scrambled and modulated in the EFM form in the DSP 101. The A/V signal processed in the DSP 101 is decoded in the A/V decoder 102 and displayed on the displayer 103.

The contents, in which the “viewing restriction” function is set, can be reproduced only when a manager inputs correct information corresponding to the viewing restriction function to the controller 104.

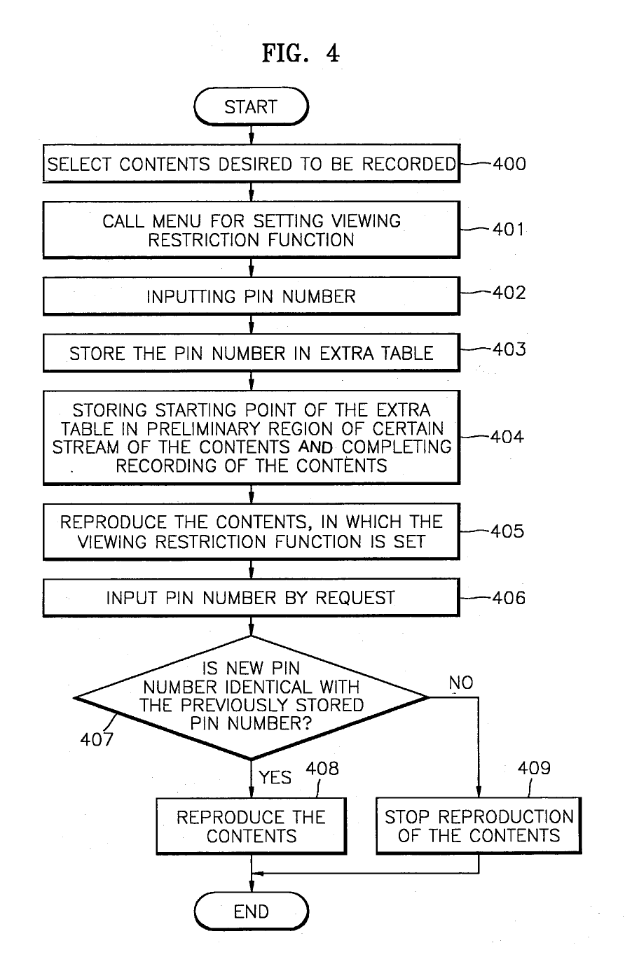

FIG. 4 is a flowchart of a viewing restriction method according to another embodiment of the present invention. Referring to FIG. 4, a viewing restriction method includes selecting contents desired to be recorded and recording the selected contents in operation 400. In operation 401, a first menu for setting a viewing restriction function. A password is entered in operation 402. The password is stored in an extra table in operation 403. A starting point is stored in the extra table in a preliminary region of a certain stream in operation 404. The contents, in which the viewing restriction function is set, is produced in operation 405. A password is pressed (input) when requested to do so in operation 406. It is determined whether the input password is identical with the previously stored password in operation 407 and the corresponding contents are reproduced from the optical recording disk 100 in operation 408 if the input password is identical. If the input password is not identical, the reproduction of the corresponding contents is stopped in operation 409.

Next, the present invention will be described in greater detail with reference to FIGS. 1 and 4.

In a case of a DVD video type having numerous preliminary regions of a VMGI management table or a VTSI management table, it is possible to store the viewing restriction information in the preliminary region. However, since a DVD-VR type does not have a sufficient preliminary region, the viewing restriction information is stored in the extra table, and a point at which the extra table starts is stored in the preliminary region.

A user selects contents desired to be recorded in operation 400. In a case of recording contents displayed on the displayer 103, a second menu of recording contents is called in response to an input signal input by the user or generated by keys provided with a remote controller or a player. The controller 104 displays the menu of recording contents on the displayer 103 in response to the input signal. The user can select the function of “recording of contents” from the menu for recording contents displayed on the displayer 103.

If the contents desired to be recorded by the user are determined as inappropriate to people under age, like contents of violence or sex, the first menu for setting the viewing restriction function is called with the use of the input signal in operation 401. The controller 104 displays the first menu for setting the viewing restriction function in response to the input signal and requests the password, i.e., the pin number.

The user inputs the password at the request of the controller 104 in operation 402. The user who inputs the correct password is a manager who manages the reproduction of the contents.

After the user, i.e., the manager, inputs the password, the controller 104 stores the password in the extra table in operation 403.

After the password is stored in the extra table, the controller 104 stores the point at which the extra table starts in the preliminary region of the certain stream, and completes recording of the whole contents in operation 404. The preliminary region of the certain stream in which the password is stored is the preliminary region of various information tables for recording or reproducing contents, in which information on the disk 100 or the title of the contents is contained.

After the recording of the contents is completed, the user reproduces the contents, in which the viewing restriction function is set, in operation 405, and the controller 104 accesses the point at which the extra table starts in the preliminary region and demands the user to input the password to reproduce the contents.

The user inputs the password at the request of the controller 104 in operation 406.

The controller 104 accesses the starting point of the extra table stored in the preliminary region and determines whether the input password is identical with the previously stored password in operation 407.

If the input password is determined to be identical with the previously stored password, the corresponding contents are reproduced in operation 408. A pickup unit (not shown) reads an A/V signal from the optical disk 100. The A/V signal read by the pickup unit is scrambled and modulated in the EFM form in the DSP 101. The A/V signal processed in the DSP 101 is decoded in the A/V decoder 102 and displayed on the displayer 103.

However, as a result of the determination on the input pin number, if the newly input password is not identical with the previously stored password, reproducing of the corresponding contents is stopped in operation 409. Since the user may input wrong password by mistake, it is allowed for the user to have a predetermined number of chances to input the password correctly. If the newly input password is still not identical with the previously stored password after a predetermined number of password entry tries, reproduction of the corresponding contents is stopped. In addition, the wrong passwords input by any disk user are sequentially stored in a memory (not shown) by the controller 104 and are provided to the manager. Like this, the manager can find out when the user tried to reproduce contents and what contents the user tried to reproduce based on the wrongly input passwords.

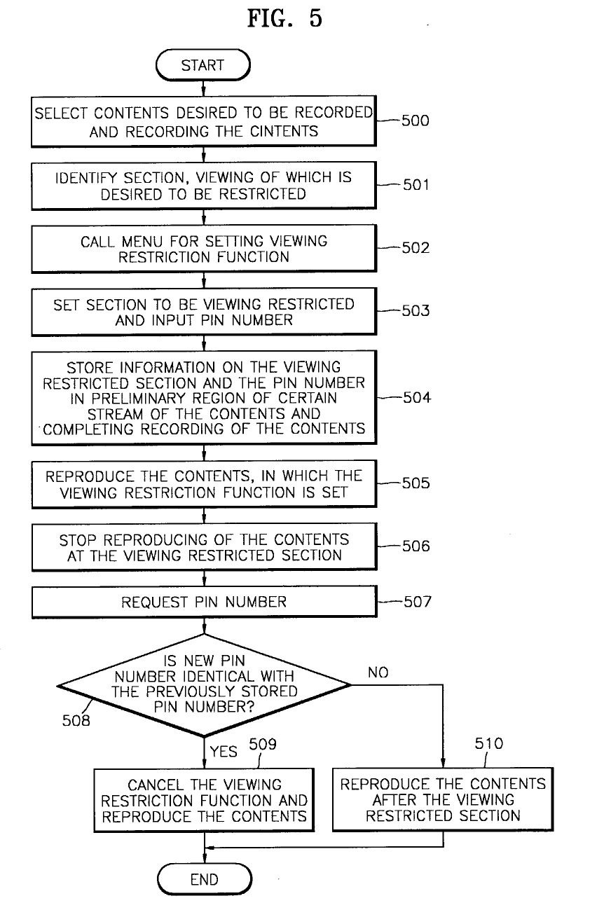

FIG. 5 is a flowchart of a viewing restriction method according to another embodiment of the present invention. Referring to FIG. 5, the viewing restriction method includes selecting desired contents to be recorded and recording the selected contents in operation 500, and identifying a section which is desired to be viewing-restricted, during recording of the contents in operation 501. A first menu for setting a viewing restriction function is called in operation 502. A section to be viewing-restricted is set, and a pin number (password) is input in operation 503. Information is stored on the section, in which the viewing restriction function is set, the password is entered in a preliminary region of a certain stream, and recording of the contents is completed in operation 504. The contents, in which the viewing restriction function is set, is temporarily reproduced in operation 505. The reproduction of the contents is stopped at the viewing-restricted section in operation 506. An input of a password is requested in operation 507. It is determined whether the newly input password is identical with the previously stored password in operation 508. Any content restriction and starting the reproduction of the contents is canceled in operation 509, and the contents disposed next to the viewing-restricted section are reproduced in operation 510.

Next, the present invention will be described in greater detail with reference to FIGS. 1 and 5.

A user selects the contents desired to be recorded and records the selected contents in operation 500. In a case of recording the contents displayed on the displayer 103, a second menu for recording the contents is called in response to an input signal input by the user or generated by keys provided with a remote controller or a player. The controller 104 displays the second menu for recording the contents on the displayer 103 in response to the input signal. The user can select a function of “recording of contents” from the second menu for recording contents displayed on the displayer 103.

The user identifies a section of the contents, which contains violent or sex-related scenes, during or after recording the contents in operation 501.

In order to apply the viewing restriction function to the section, in which the violent or sex-related material is recorded, the first menu for setting the viewing restriction function is called in operation 502. The controller 104 displays the first menu for setting the viewing restriction function with in response to the input signal and demands the user to input information on a section of the contents, to which the viewing restriction function is desired to be applied, and the password.

The user sets a starting point and an ending point of the section, to which the viewing restriction function is desired to be applied, at the request of the controller 104 and inputs a password to selectively reproduce the viewing-restricted section in operation 503. The user who can set the section to be viewing-restricted and input the password is a manager who manages later reproduction of the contents by inputting the password to the controller 104.

If the user, i.e., the manager sets the section to be viewing-restricted and inputs the password, the controller 104 stores information on the viewing-restricted section and the password in the preliminary region of the certain stream and completes recording of the whole contents in operation 504. The preliminary region of the certain stream, in which the information on the viewing-restricted section and the password are stored, is a preliminary region of various information tables, in which information on the optical disk 100 and the title of the contents is contained.

For example, there is a volume information table in the optical disk 100, in which information required to reproduce the optical disk 100 is stored. The volume information table includes a video title set information (VTSI) management table and a video manager information (VMGI) management table. The password for viewing restriction is stored in preliminary regions of the VTSI and VMGI management tables. The VTSI management table is a table, in which video title set information (VTSI) is stored, and is constituted of 2048 bytes. The preliminary region of the VTSI management table, in which the information on the viewing-restricted section and the password are recorded, is located between the 16^{th} and 27^{th} bytes, between the 38^{th} and 127^{th} bytes, between the 132^{nd} and 191^{st} bytes, between the 232^{nd} and 255^{th} bytes, between the 268^{th} and 339^{th} bytes, between the 348^{th} and 511^{th} bytes, between the 580^{th} and 595^{th} bytes, between the 790^{th} and 791 st bytes, and/or between the 984^{th} and 2047^{th} bytes. The VMGI management table is a table, in which video management information is stored, and is constituted of 2292 bytes. The preliminary region of the VMGI management table, in which the information on the viewing-restricted section and the password are recorded, is located between the 16^{th} and 27^{th} bytes, between the 48^{th} and 61^{st} bytes, between the 104^{th} and 127^{th} bytes, between the 136^{th} and 191^{st} bytes, between the 224^{th} and 255^{th} bytes, between the 268^{th} and 339^{th} bytes, and/or between the 348^{th} and 1023^{rd} bytes.

After the recording of the contents is completed, the user reproduces the contents, a certain section of which is viewing-restricted, in operation 505. A pickup unit (not shown) reads an A/V signal from the optical disk 100. The A/V signal read by the pickup unit is scrambled and modulated in the EFM form in the DSP 101 and is unscrambled and demodulated. The A/V signal processed in the DSP 101 is decoded in the A/V decoder 102 and displayed on the displayer 103.

The reproduction of the contents is temporarily stopped at the viewing-restricted section in operation 506. The controller 104 accesses the information on the viewing-restricted section stored in the preliminary region and temporarily stops reproducing of the contents at the viewing-restricted section. The controller 104 demands the user to input the pin number to reproduce the viewing-restricted section in operation 507. The controller 104 determines whether the newly input pin number is identical with the previously stored pin number in operation 508.

As the result of the determination, if the newly input pin number is identical with the previously stored password, setting of the viewing-restricted section is cancelled and the contents is continuously reproduced in operation 509.

However, if the newly input password is not identical with the previously stored password, the corresponding contents disposed directly next to the viewing-restricted section are reproduced. Since the user may input wrong password by mistake, it is allowed for the user to have a predetermined number of chances to input the password correctly. If the newly-input password is still not identical with the previously-stored password after the predetermined number of password entry tries, the corresponding contents directly after the viewing-restricted section are reproduced in operation 510. In addition, the wrong passwords input by any disk user are sequentially stored in a memory (not shown) by the controller 104 and are provided to the manager. The manager can find out when the user tried to reproduce the contents and what contents the disk user tried to reproduce based on the incorrectly input wrong password.

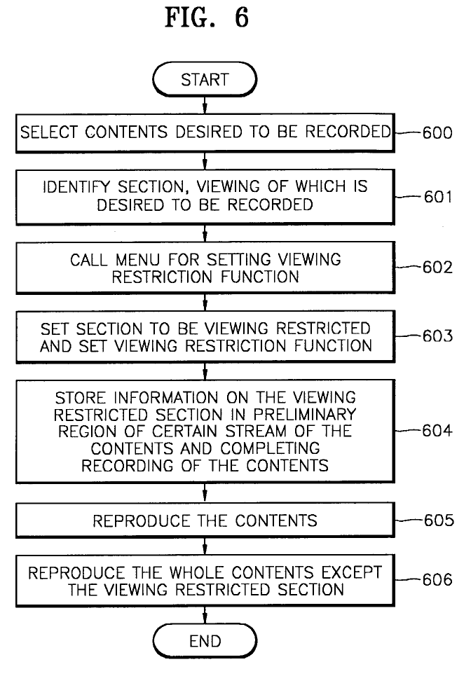

FIG. 6 is a flowchart of a viewing restriction method according to another embodiment of the present invention. Referring to FIG. 6, the viewing restriction method includes selecting contents desired to be recorded and recording the selected contents in operation 600. A section of the contents is identified, viewing of which is desired to be restricted, in operation 601. A first menu for setting a viewing restriction function is called in operation 602. The section of the contents, to which the viewing restriction function will be applied, is set and the viewing restriction function is set in operation 603. Information on the viewing-restricted section is stored in a preliminary region of a certain stream, and recording of the contents is completed in operation 604. The corresponding contents is reproduced in operation 605, and the whole contents except for the viewing-restricted section is reproduced in operation 606.

The present invention will be described in greater detail with reference to FIGS. 1 and 6.

A user selects the contents desired to be recorded and records the selected contents in operation 600. In a case of recording the contents displayed on the displayer 103, a second menu for recording the contents is called in response to an input signal input by the user or generated by keys provided with a remote controller or a player. The controller 104 displays the second menu for recording the contents on the displayer 103 in response to the input signal. The user can select “recording of contents” in the second menu for recording the contents displayed on the displayer 103.

The user identifies a section which contains violent or sex-related scenes, during or after recording the contents in operation 601.

In order to apply the viewing restriction function to the section, in which the violent or sex-related material is recorded, the first menu for setting the viewing restriction function is called in operation 602. The controller 104 displays the first menu for setting the viewing restriction function in response to the input signal and demands the user to input information on the section of the contents, to which the viewing restriction function is desired to be applied.

The user sets a starting point and an ending point of the section, to which the viewing restriction function is desired to be applied, at the request of the controller 104 and sets the section as a “viewing-restricted section” in operation 603. The user who can set the viewing-restricted function is a manager who manages later reproduction of the contents.

If the user, i.e., the manager, inputs the information on the viewing-restricted section, the controller 104 stores the information on the viewing-restricted section in the preliminary region of the certain stream and completes recording of the whole contents in operation 604. The preliminary region of the certain stream, in which the information on the viewing-restricted section and the pin number are stored, is a preliminary region of various information tables, in which information on the optical disk 100 and the title of the contents is contained.

For example, there is a volume information table in the optical disk 100, in which information required to reproduce the optical disk 100 is stored. The volume information table includes a video title set information (VTSI) management table and a video manager information (VMGI) management table. The pin number for viewing restriction is stored in preliminary regions of the VTSI and VMGI management tables. The VTSI management table is a table, in which video title set information (VTSI) is stored, and is constituted of 2048 bytes. The preliminary region of the VTSI management table, in which the information on the viewing-restricted section is recorded, is located between the 16^{th} and 27^{th} bytes, between the 38^{th} and 127^{th} bytes, between the 132^{nd} and 191^{st} bytes, between the 232^{nd} and 255^{th} bytes, between the 268^{th} and 339^{th} bytes, between the 348^{th} and 511^{th} bytes, between the 580^{th} and 595^{th} bytes, between the 790^{th} and 791^{th} bytes, and/or between the 984^{th} and 2047^{th} bytes. The VMGI management table is a table, in which video management information is stored, and is constituted of 2292 bytes. The preliminary region of the VMGI management table, in which the information on the viewing-restricted section is recorded, is located between the 16^{th} and 27^{th} bytes, between the 48^{th} and 61^{st} bytes, between the 104^{th} and 127^{th} bytes, between the 136^{th} and 191^{st} bytes, between the 224^{th} and 255^{th} bytes, between the 268^{th} and 339^{th} bytes, and/or between the 348^{th} and 1023^{rd} bytes.

After the recording of the contents is completed, the user reproduces the contents, having a certain section to the viewing restriction function is applied, in operation 605. A pickup unit (not shown) reads an A/V signal from the optical disk 100. The A/V signal read by the pickup unit has been scrambled and modulated in the EFM form in the DSP 101 and unscrambled and demodulated. The A/V signal processed in the DSP 101 is decoded in the A/V decoder 102 and displayed on the displayer 103.

The whole contents except the viewing-restricted section are reproduced in operation 606. The “viewing-restricted section” can be reproduced only when the manager inputs the information relating to the viewing-restricted section to the controller 104.

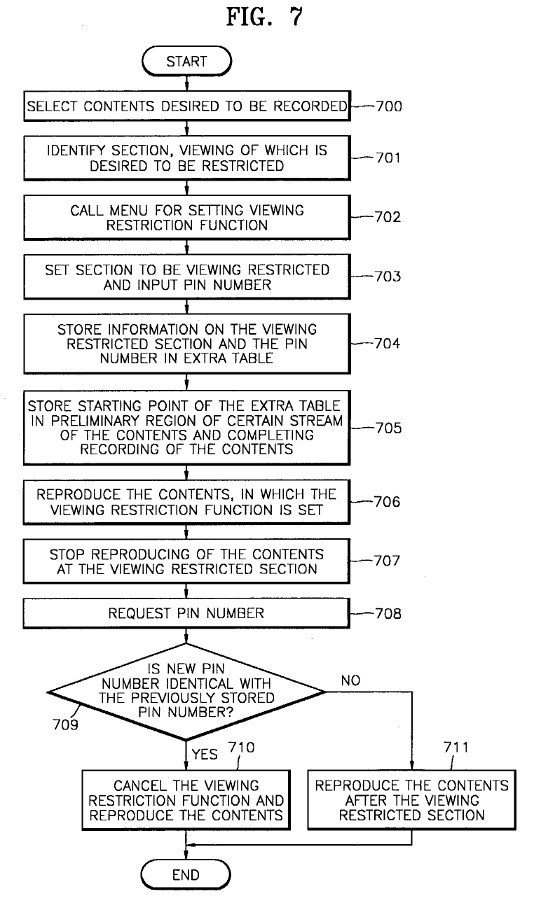

FIG. 7 is a flowchart of a viewing restriction method according to another embodiment of the present invention. Referring to FIG. 7, the viewing restriction includes selecting contents desired to be recorded and recording the selected contents in operation 700. A section of the contents, to which a viewing restriction function is desired to be applied, is identified during recording the contents in operation 701. A first menu for setting a viewing restriction function is called in operation 702. The section to be viewing-restricted is set, and a password is input in operation 703. Information on the section, in which the viewing restriction function is set, is stored, and the password is stored in an extra table in operation 704. A starting point of the extra table is stored in a preliminary region of a certain stream, and recording of the contents is completed in operation 705. The contents, in which the viewing restriction function is set, is temporarily reproduced in operation 706. The reproduction of the contents is stopped at the viewing-restricted section in operation 707. The password is requested in operation 708. It is determined whether a newly input password is identical with the previously stored password in operation 709. The restriction of viewing of the contents is canceled, and reproducing of the contents starts in operation 710. The contents disposed next to the viewing-restricted section is reprodeced in operation 711.

Hereinafter, the present invention will be described in greater detail with reference to FIGS. 1 and 7.

In a case of a DVD having a lot of preliminary regions of a VMGI management table or a VTSI management table, it is possible to store viewing restriction information in at least one of the preliminary regions. However, since a DVD-VR type does not have a sufficient preliminary region, the viewing restriction information is stored in the extra table, and the starting point at which the extra table starts is stored in the preliminary region.

A user selects the contents desired to be recorded and records the selected contents in operation 700. In a case of recording the contents displayed on the displayer 103, a second menu for recording the contents is called in response to an input signal input by the user and/or generated by keys provided with a remote controller or a player. The controller 104 displays the second menu for recording the contents on the displayer 103 in response to the input signal. The user can select a function of “recording of contents” from the second menu for recording the contents displayed on the displayer 103.

The user identifies the section of the contents, in which violent or sex-related material is recorded, during or after recording the contents in operation 701.

In order to apply the viewing restriction function to the section, in which the violent or sex-related material is recorded, the first menu for setting the viewing restriction function is called in operation 702. The controller 104 displays the first menu for setting the viewing restriction function in response to the input signal and demands the user to input information on the section of the contents, to which the viewing restriction function is desired to be applied, and the password.

The user sets the starting point and an ending point of the section, to which the viewing restriction is desired to be applied, at a request of the controller 104 and inputs the password to selectively reproduce the viewing-restricted section in operation 703. The user who can set the viewing-restricted section and input the password is a manager who manages later reproduction of the contents.

After the user, i.e., the manager, sets the viewing-restricted section and inputs the pin number, the controller 104 stores the viewing-restricted section and the password in the extra table in operation 704.

Next, the controller 104 stores the starting point of the extra table in the preliminary region of the certain stream and completes recording of the whole contents in operation 705. The preliminary region of the certain stream is a preliminary region of various information tables for recording or reproducing contents, in which information on the optical disk 100 or the title of the contents is contained.

After the recording of the contents is completed, the user reproduces the contents, a certain section of which is viewing-restricted, in operation 706. A pickup unit (not shown) reads an A/V signal from the optical disk 100. The A/V signal read by the pick up unit has been scrambled and modulated in the EFM form in the DSP 101 and is unscrambled and demodulated. The A/V signal processed in the DSP 101 is decoded in the A/V decoder 102 and displayed on the displayer 103.

The reproduction of the contents is temporarily stopped at the viewing-restricted section in operation 707. The controller 104 accesses the information on the viewing-restricted section stored in the preliminary region and temporarily stops the reproduction of the contents at the viewing-restricted section. The controller 104 demands the user to input the password to reproduce the viewing-restricted section in operation 708. The controller 104 accesses the starting point of the extra table in a preliminary region and determines whether the newly input password is identical with the previously stored password in the extra table, in operation 709. As a result of the determination, if the newly input password is identical with the previously stored password, setting of the viewing-restricted section is cancelled and the contents is continuously reproduced in operation 710.

However, if the newly input password is not identical with the previously stored password, the corresponding contents disposed directly next to the viewing-restricted section are reproduced in operation 711. Since the user may input wrong password by mistake, it is allowed for the user to have a predetermined number of chances to input the password correctly. If the newly input password is still not identical with the previously-stored password after the predetermined number of password entry tries, the corresponding contents directly after the viewing-restricted section are reproduced. In addition, the wrong passwords input by any disk user are sequentially stored in a memory (not shown) by the controller and are provided to the manager. The manager can find out when the user tried to reproduce the contents and what contents the user tried to reproduce based on the incorrectly input wrong passwords.

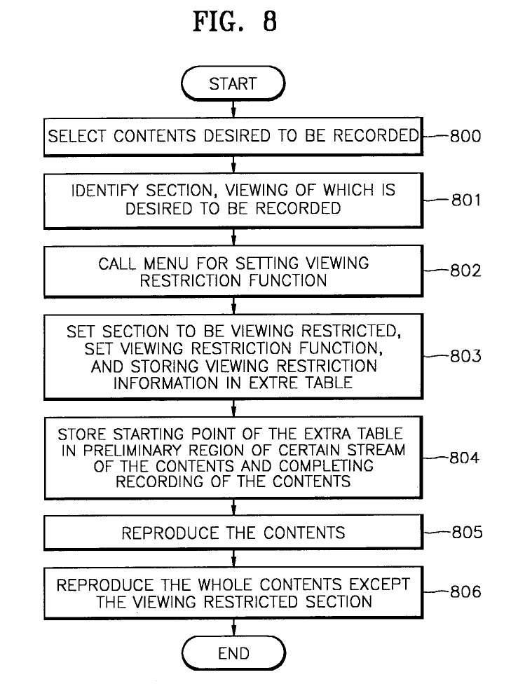

FIG. 8 is a flowchart of a viewing restriction method according to another embodiment of the present invention. Referring to FIG. 8, the viewing restriction method includes selecting contents desired to be recorded and recording the selected contents in operation 800. A section of the contents, viewing of which is desired to be restricted, is identified in operation 801. A first menu for setting the viewing restriction function is called in operation 802. A section of the contents, to which a viewing restriction function will be applied, and the viewing restriction function are set, and information on the viewing-restricted section is stored in an extra table in operation 803. A starting point of the extra table is stored in a preliminary region of a certain stream, and recording of the contents is completed in operation 804. The corresponding contents is reproduced in operation 805, and the whole contents except for the viewing-restricted section is reproduced in operation 806.

The present invention will be described in greater detail with reference to FIGS. 1 and 8.

A user selects contents desired to be recorded and records the selected contents in operation 800. In a case of recording the contents displayed on the displayer 103, a second menu for recording the contents is called in response to an input signal input by the user and/or generated by keys provided with a remote controller or a player. The controller 104 displays the second menu for recording the contents on the displayer 103 in response to the input signal. The user can select a function of “recording of contents” in the second menu for recording the contents displayed on the displayer 103.

The user identifies the section of the contents which contains violent or sex-related scenes, during or after recording the contents in operation 801.

In order to apply the viewing restriction function to the section, in which the violent or sex-related material is recorded, the first menu for setting the viewing restriction function is called in operation 802. The controller 104 displays the first menu for setting the viewing restriction function in response to the input signal and demands the user to input information on the section of the contents, to which the viewing restriction function is desired to be applied.

The user sets the starting point and an ending point of the section to be viewing-restricted at a request of the controller 104, sets the section as a “viewing-restricted section”, and stores information on the viewing-restricted section in the extra table in operation 803. The user who can set the viewing-restricted function is the same as a manager who manages later reproduction of the contents.

If the user, i.e., the manager, inputs the information on the viewing-restricted section, the controller 104 stores the starting point of the extra table in the preliminary region of the certain stream and completes recording of the whole contents in operation 804. The preliminary region of the certain stream, in which the information on the viewing-restricted section and the password are stored, is a preliminary region of various information tables, in which information on the optical disk 100 and the title of the contents is contained.

After the recording of the contents is completed, the user reproduces the contents, having the certain section to which the viewing restriction function is applied, in operation 805. A pickup unit (not shown) reads an A/V signal from the optical disk 100. The A/V signal read by the pickup unit has been scrambled and modulated in the EFM form in the DSP 101 and is unscrambled and demodulated. The A/V signal processed in the DSP 101 is decoded in the A/V decoder 102 and displayed on the displayer 103.

The whole contents except the viewing-restricted section are reproduced in operation 806. The “viewing-restricted section” can be reproduced by the manager.

As described above, according to the present invention, it is possible to prevent minors from viewing a violent or sex-related material by setting viewing restriction information or a password (pin number) in a certain region of contents or setting a section of the contents as a viewing-restricted section while recording the contents.

While this invention has been particularly shown and described with reference to preferred embodiments thereof, it will be understood by those skilled in the art that various changes in form and details may be made therein without departing from the spirit and scope of the invention as defined by the appended claims and equivalents thereof.

What is claimed is:

1. A viewing restriction method of selecting desired contents and recording/reproducing the contents onto/from an optical recording medium, the method comprising:
setting a password using a menu for restricting viewing of contents, storing the password in a preliminary region of a certain stream of the contents, and recording the contents in the optical recording medium; and
reproducing the stored contents from the optical recording medium if a newly input password is identical to the password stored in the preliminary region of the certain stream of the contents.

2. The method of claim 1, wherein the preliminary region, in which the password is stored, is a preliminary region of a predetermined information table used to record/reproduce information about the contents into/from the optical recording medium.

3. The method of claim 1, wherein the reproducing of the stored contents comprises:
storing the newly input password in a memory if the newly input pin number is not identical with the previously stored password; and
providing information about the newly input password to a manager when another password input by the manager is identical to the stored password.

4. A viewing restriction method of recording/reproducing multiple contents onto/from an optical recording medium, the method comprising:
setting viewing restriction information on predetermined contents, storing the viewing restriction information in a preliminary region of a certain stream of the contents, and recording the contents in the optical recording medium; and
selecting desired contents from the multiple contents except the predetermined contents in which the viewing restriction information is set, and reproducing the selected contents from the optical recording medium.

5. The method of claim 4, wherein the preliminary region, in which the viewing restriction information is recorded, is a preliminary region of a predetermined information table used to record/reproduce information about the contents into/from the optical recording medium.

6. The method of claim 4, wherein the reproducing of the selected contents comprises:
sequentially displaying the multiple contents except for the predetermined contents in which the viewing restriction information is set.

7. The method of claim 4, wherein the reproducing of the selected contents comprises:
reproducing the predetermined contents, in which the viewing restriction information is set, when an input is identical to the viewing-restriction information.

8. A viewing restriction method for selecting desired contents and recording/reproducing the contents into/from an optical recording medium, the method comprising:
setting a password using a menu for restricting viewing of the contents and storing information on the password;
storing a starting point of the information on the password in a preliminary region of a certain stream of the contents and recording the contents in the optical recording medium; and
accessing the preliminary region and reproducing the contents if a newly input password is identical to the password stored in the preliminary region.

9. The method of claim 8, wherein the preliminary region, in which the starting point of the information on the password is stored, is a preliminary region of a predetermined information table used to record/reproduce information about the contents into/from the optical recording medium.

10. The method of claim 8, wherein the reproducing of the contents comprises:
recording the newly input pin number in a memory if the newly input password is not identical to the previously stored password; and
providing the newly input password to a manager when another input password input by the manager is identical to the previously stored password.

11. A viewing restriction method of selecting desired contents and recording/reproducing the contents into/from an optical recording medium, the method comprising:
setting a section of the contents, viewing of which is desired to be restricted, setting a password to reproduce the viewing-restricted section, and storing the password in a preliminary region of a certain stream of the contents when recording the whole contents in the optical recording medium; and
reproducing the viewing-restricted section from the optical recording medium if a newly input password is identical to the password stored in the preliminary region.

12. The method of claim 11, wherein the preliminary region, in which the password is stored, is a preliminary region of a predetermined information table used to record/reproduce information about the whole contents into/from the optical recording medium.

13. The method of claim 11, wherein the reproducing of the viewing-restricted section comprises:
recording the newly input password in a memory if the newly input pin number is not identical with the previously stored password; and
providing the newly input password to a manager who inputs another password which is identical to the previously stored password.

14. A viewing restriction method of selecting desired contents and recording/reproducing the contents into/from an optical recording medium, the method comprising:
setting a section of the contents, viewing of which is desired to be restricted, and storing information on the section to be viewing-restricted in a preliminary region of a certain stream of the contents when recording the contents in the optical recording medium; and
reproducing the contents except the viewing-restricted section from the optical recording medium.

15. The method of claim 14, wherein the preliminary region, in which the information on the viewing-restricted region is stored, is a preliminary region of a predetermined information table used to record/reproduce information into/from the optical recording medium.

16. The method of claim 14, wherein the viewing-restricted section can be reproduced only when input information is identical to the information.

17. A viewing restriction method of selecting desired contents and recording/reproducing the contents into/from an optical recording medium, the method comprising:
setting a section of the contents, viewing of which is desired to be restricted, setting a password to reproduce the viewing-restricted section, and storing information on the viewing-restricted section when recording the contents in the optical recording medium;
storing a starting point of the information on the viewing-restricted section in a preliminary region of a certain stream of the contents and recording the contents in the optical recording medium; and
accessing the preliminary region and reproducing the contents from the optical recording medium if a newly input password is identical to the password stored in the preliminary region.

18. The method of claim 17, wherein the preliminary region, in which the starting point of the information on the viewing-restricted section is stored, is a preliminary region of a predetermined information table used to record/reproduce information into/from the optical recording medium.

19. The method of claim 17, wherein the accessing of the preliminary region comprises:
recording the newly input password in memory if the newly input password is not identical to the previously stored password; and
providing the newly input password to a manager when another password input by the manager is identical to the previously stored password.

20. A viewing restriction method of selecting desired contents and recording/reproducing the contents into/from an optical recording medium, the method comprising:
setting a section of the contents, viewing of which is desired to be restricted, and storing information on the viewing-restricted section when recording the contents;
storing a starting point of the information on the viewing-restricted section in a preliminary region of a certain stream of the contents and recording the contents in the optical recording medium; and
reproducing the contents except the viewing-restricted section from the optical recording medium.

21. The method of claim 20, wherein the preliminary region, in which the information on the viewing-restricted section is stored, is a preliminary region of a predetermined information table used to record/reproduce information into/from the optical recording medium.

22. The method of claim 20, wherein the reproducing of the contents comprises:
reproducing the viewing-restricted section when input information is identical to the information.

23. A viewing restriction method of recording/reproducing contents and information about the contents into/form an optical recording medium in a recording/reproducing apparatus, the method comprising:
recording the contents and the information including a viewing restriction information corresponding to a portion of the contents into the optical recording medium; and
reproducing the contents except for the portion of the contents from the optical recording medium in response to determining when input data is not identical to the viewing restriction information reproduced from the optical recording medium.

24. The method of claim 23, wherein the information comprises volume information table including one of a video title set information management table and a video manager information management table, and the recording of the contents and the information comprises:
setting the viewing restriction information in the one of the video title set information management table and the video manager information management table.

25. The method of claim 24, wherein the recording of the contents and the information comprises:
setting the viewing restriction information to be located between the 16^{th} and 27^{th} bytes, between the 38^{th} and 127^{th} bytes, between the 132^{nd} and 191^{st} bytes, between the 232^{nd} and 255^{th} bytes, between the 268^{th} and 339^{th} bytes, between the 348^{th} and 511^{th} bytes, between the 580^{th} and 595^{th} bytes, between the 790^{th} and 791^{st} bytes, and/or between the 984^{th} and 2047^{th} bytes of the video title set information management table if the video title set information management table is constituted of 2048 bytes.

26. The method of claim 24, wherein the recording of the contents and the information comprises:
setting the viewing restriction information to be located between between the 16^{th} and 27^{th} bytes, between the 48^{th} and 61^{st} bytes, between the 104^{th} and 127^{th} bytes, between the 136^{th} and 191^{st} bytes, between the 224^{th} and 255^{th} bytes, between the 268^{th} and 339^{th} bytes, and/or between the 348^{th} and 1023^{rd} bytes of the video manager information management table if the video manager information management table is constituted of 2292 bytes.

27. The method of claim 23, wherein the recording of the contents and the information comprises:
setting a password as the viewing restriction information.

28. The method of claim 23, wherein the recording of the contents and the information comprises:
inserting starting and ending positions of the portion of the contents in the viewing restriction information.

29. The method of claim 28, wherein the reproducing of the contents comprises:
preventing the portion of the contents between the starting position and the ending position of the contents from being reproduced.

30. The method of claim 23, wherein the recording of the contents and the information comprises:
displaying a menu on a display to receive the viewing restriction information through the menu.

31. The method of claim 23, wherein the recording of the contents and the information comprises:
displaying a menu on a display to receive a selection of the portion from the contents and the viewing restriction information.

32. The method of claim 23, wherein the reading of the information comprises:
displaying a menu on a display in response to the viewing restriction information to receive input data through the menu when the information includes the viewing restriction information.

33. The method of claim 23 wherein the reproducing of the contents comprises:
preventing the portion of the determining from being displayed on a display when input data is not identical to the viewing restriction information.

34. The method of claim 23, wherein the reproducing of the contents comprises:
preventing the portion of the determining from being reproduced from the optical recording medium when input data is not identical to the viewing restriction information.

35. The method of claim 23, wherein the reproducing of the contents comprises;
preventing the portion of the contents from being read from the optical recording medium.

36. The method of claim 23, wherein the information is another portion of the contents.

37. The method of claim 23, wherein the contents comprises first, second, and third contents, the portion of the contents is the second contents, and the reproducing of the contents comprises:
reproducing the first and third contents except for the second contents.

38. The method of claim 37, wherein the reproducing of the contents comprises:
receiving an input from an external source; and
displaying the first and third contents on a display seamlessly when the input is not identical to the view restriction information.

39. The method of claim 38, wherein the reproducing of the contents comprises:
displaying the first, second, and third contents on a display seamlessly when the input is identical to the view restriction information.

40. The method of claim 23, wherein the contents comprises a plurality of sections, the portion of the contents comprises one of the sections of the contents, and the reproducing of the contents comprises:
reproducing the sections except for the one of the sections of the content.

41. A viewing restriction method of reproducing contents and information about the contents from an optical recording medium, the method comprising:
reproducing a viewing restriction information contained in the information; and
reproducing the contents except for a portion of the contents from the optical recording medium when input data from an external source is not identical to the viewing restriction information on the portion of the contents.

42. The method of claim 41, wherein the reproducing of the contents comprises:
reproducing the viewing restriction information from the optical record medium to generate a password; and
reproducing the contents except for the portion of the contents corresponding to the viewing restriction information upon determining when the input data is not identical to the password.

43. The method of claim 42, wherein the reading of the information comprises:
preventing the portion of the contents from being read from the optical record medium.

44. The method of claim 42, wherein the reading of the information comprises:
reading the contents from optical record medium; and
preventing the portion of the contents from being displayed on a display.

45. A viewing restriction apparatus recording/reproducing contents and information about the contents into/form an optical recording medium in a recording/reproducing apparatus, the method comprising:
a recorder recording the contents and the information having a view restriction information corresponding to a portion of the contents into the optical recording medium; and
a player reading the information from the optical recording medium and reproducing the contents except for the portion of the contents from the optical recording medium when a newly input password input from an external source is not identical to the view restriction information.

46. A viewing restriction apparatus reproducing contents and information about the contents from an optical recording medium in an optical reproducing apparatus, the method comprising:
a reproducing unit reproducing the information from the optical recording medium, which contains the contents and the information having a viewing restriction information and a password corresponding to a portion of the contents; and
a controller determining whether the information includes the viewing restriction information, receiving input data from an external source, and controlling the reproducing unit to reproduce the contents except for the portion of the contents when the input data is not identical to the stored password reproduced from the optical recording medium.
